(19) United States
(12) Patent Application Publication
(10) Pub. No.: US 2005/0155024 A1
(43) Pub. Date: Jul. 14, 2005

(54) Method of transforming java bytecode into a directly interpretable compressed format

(76) Inventors: Jeffrey Wannamaker, London (CA); Peter G.N. Scheyen, London (CA)

Correspondence Address: MOSER, PATTERSON & SHERIDAN L.L.P., 595 SHREWSBURY AVE, STE 100, FIRST FLOOR, SHREWSBURY, NJ, 07702, US

(21) Appl. No.: 10/757,620

(22) Filed: Jan. 14, 2004

(51) Int. Cl. G06F 9/45

(52) U.S. Cl. 717/151; 717/152

(57) ABSTRACT

A method of transforming Java Jar files into a compressed format that remains directly interpretable and retains symbolic linkages within a target.

### BACKGROUND OF THE INVENTION

1. Field of the Invention

The present invention relates to data processing systems and, more particularly, to a process for producing compressed Java Jar files including byte code which remains directly interpretable by a Java virtual machine.

2. Description of the Related Art

Programs written in the Java programming language are compiled into class files and are typically grouped together by placing them in an archive file known as a Java Archive (Jar) file. These Jar files contain all of the class files generated by compiling the application source code. When the applications are interpreted many additional classes are typically required. These classes come from the Java runtime library. For embedded systems, such as television set top boxes, cell phones, PDA's and the like that support the interpretation of Java code, the classes that make up the Java runtime library are often built into the device and reside in some form of non-volatile memory such as Flash memory. Applications, on the other hand, are downloaded into the device over a network at the time the user wishes to execute them.

A problem faced by embedded systems developers is that many of these devices have severely constrained memory resources, and it is a serious challenge to get the required Java libraries and applications to fit into available memory. This problem is exacerbated by the fact that Java class files are large and not particularly efficient representations. Java employs runtime binding which requires that the class files contain a great deal of symbolic information in the form of strings. When a group of class files are combined into a Jar file, there will be many redundant copies of the same string information.

Two techniques are in common usage to combat this problem: jar file compression, and obfuscation. The jar file format supports the use of zip type data compression on individual files within the jar. Such compressed jars are typically on the order of 50% of the size of an uncompressed jar. The drawback of using compressed jars is that they cannot be executed without first decompressing them. This means that the device must have enough memory available to hold the compressed jar, in addition to uncompressed copies of each referenced class. Hence such compressed jars are useful for reducing the bandwidth required to transmit an application jar over a network, but do not really help with reducing device memory requirements. Obfuscation involves the automated modification of class, method, and field names from the original names employed by the application developers to arbitrary names. Obfuscation was originally employed to make reverse engineering Java applications more difficult since the arbitrary names make it much harder to understand the code. However, if the arbitrary names are made as short as possible, the application Jar is reduced in size. The reduction in size achieved by traditional obfuscation can be on the order of 15% to 20% for large applications. Unlike compressed jars, obfuscated jars are directly executable. The small size reduction achieved, however, is of limited use.

### SUMMARY OF THE INVENTION

A method processing a Java Archive (JAR) file to provide a application file adapted for a target environment in accordance with one embodiment of the invention comprises removing from the JAR file at least a portion of information not necessary for running the application; mapping at least one of application defined class, field and method names to shorter names; and mapping at least one of target environment defined class, field and method names to corresponding target device names.

### BRIEF DESCRIPTION OF THE DRAWINGS

The teachings of the present invention can be readily understood by considering the following detailed description in conjunction with the accompanying drawings, in which:

FIG. 1 depicts a high-level block diagram of an information distribution system suitable for use with the present invention;

FIG. 2 depicts a high level block diagram of a controller topology suitable for use in the information distribution system of FIG. 1; and

FIG. 3 depicts a flow diagram of a method according to an embodiment of the present invention.

To facilitate understanding, identical reference numerals have been used, where possible, to designate identical elements that are common to the figures.

### DETAILED DESCRIPTION

The subject invention will be described within the context of a process denoted as “Grinding,” in which a number of techniques are employed to produce compressed Java jar files that remain directly interpretable while achieving a significant reduction in size. In addition, all class, method and field bindings remain symbolic, thereby preserving polymorphism. The Grinding process transforms Java jars into a format known as a “ground” jar. Since a ground jar is in a different format than a Java jar, it cannot be interpreted by a standard Java Virtual Machine (VM), but only by a virtual machine that has been “grind enabled.” If desired, however, the grind process can be reversed by an “ungrinding” process, which converts the ground Jar file into a conventional Java jar file containing conventional Java class files which may be interpreted by standard Java VM. The subject invention will be illustrated within the context of a client server environment in which a server is operative to provide video or other information to a client (e.g., a set top box) via a network (e.g., a cable, telecommunications, satellite or other network). Within the context of the present invention, the term executable is defined as the interpretation of byte code by a Java virtual machine (VM) and not execution of machine code by a central processing unit (CPU).

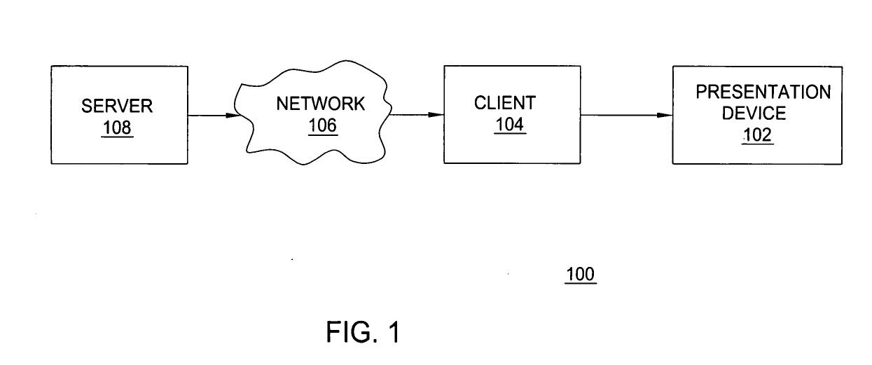

FIG. 1 depicts a high-level block diagram of an information distribution system suitable for use with the present invention. A client computer or set top box (STB) 104 is connected to a presentation device 102 such as a television or other audiovisual display device or component(s). The connection between client computer 104 and presentation device 102 allows client computer 104 to tune and/or provide a presentation signal (e.g., a television signal) to presentation device 102.

Client 104 is also connected to a communication system 106. In one embodiment, communication system 106 includes a telephone network and the Internet. In other embodiments, communication system 106 could include a network, the Internet without a telephone network, a dedicated communication system, a cable or satellite network, a single connection to another computer or any other means for communicating with another electronic entity. In one embodiment of the invention, the client comprises an STB such as the model DCT2000 manufactured by Motorola Corporation of Schaumburg, Ill. For purposes of this description, it will be assumed that the client or STB 104 comprises a device having a relatively limited amount of memory and/or processing power compared to a full featured (e.g., desktop) computer.

The communication system 106 is also connected to a server 108, such as a Unix or Windows server computer. The server 108 operates to process data structures such as Jar files in accordance with the invention and provide such processed Jar files to one or more clients 104 (though one client is depicted in FIG. 1, many clients may be connected to the server 108).

The inventors contemplate that the invention may be segmented into a server function and a client function. The server function comprises, e.g., the grind method and tools for performing the grind process, which may be implemented on the server 108 to produce a ground jar file for propagation via the network 106 to the client presentation engine 104. The client function comprises, e.g., the Java virtual machine (VM) environment and general application target environment (i.e., platform) that interprets the ground Jar file to execute the application. These functions will be discussed in more detail below with respect to the figures and the tables included herein. The functions may be implemented as a method by one or more processors. The functions may be embodied as software instructions within a signal bearing medium or a computer product. Within the context of a peer to peer network, the server functions and client functions may be both be implemented on client and/or server devices.

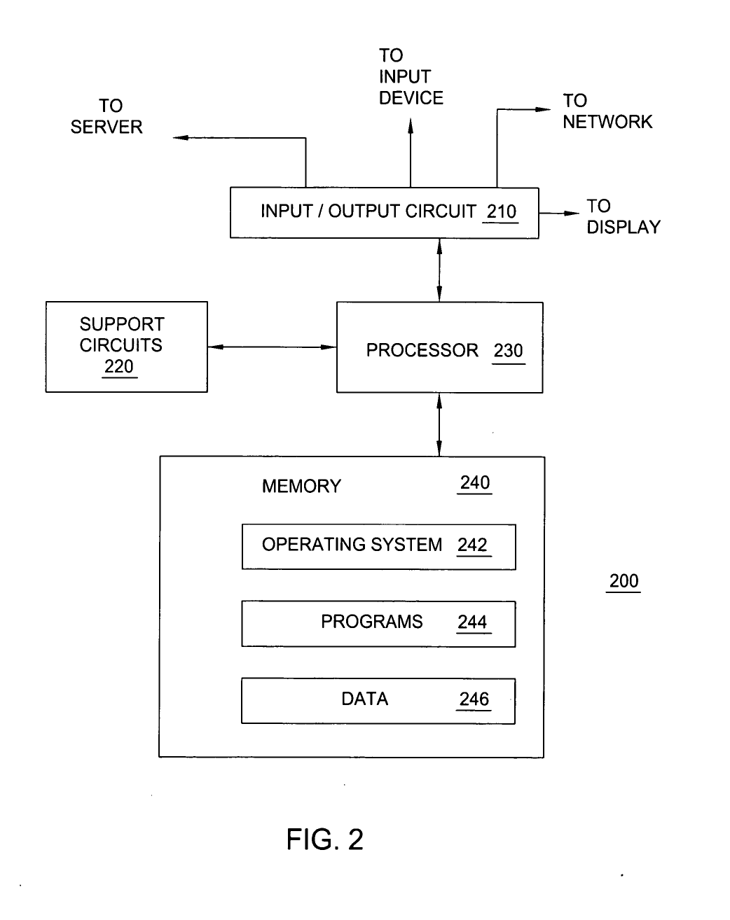

FIG. 2 depicts a high level block diagram of a controller topology suitable for use in the information distribution system of FIG. 1. Specifically, the controller 200 of FIG. 2 may be employed to implement relevant functions within the client 104 and/or server 108.

The controller 200 of FIG. 2 comprises a processor 230 as well as memory 240 for storing various control programs and other programs 244 and data 246. The memory 240 may also store an operating system 242 supporting the programs 244.

The processor 230 cooperates with conventional support circuitry such as power supplies, clock circuits, cache memory and the like as well as circuits that assist in executing the software routines stored in the memory 240. As such, it is contemplated that some of the steps discussed herein as software processes may be implemented within hardware, for example as circuitry that cooperates with the processor 230 to perform various steps. The controller 200 also contains input/output (I/O) circuitry 210 that forms an interface between the various functional elements communicating with the controller 200.

Although the controller 200 is depicted as a general purpose computer that is programmed to perform various control functions in accordance with the present invention, the invention can be implemented in hardware as, for example, an application specific integrated circuit (ASIC) or field programmable gate array (FPGA). As such, the process steps described herein are intended to be broadly interpreted as being equivalently performed by software, hardware or a combination thereof.

The controller 200 of FIG. 2 may be operably coupled to a number of devices or systems. For example, the I/O circuit 210 in FIG. 2 is depicted as interfacing to an input device (e.g., a keyboard, mouse, remote control and the like), a network (e.g., communications system 106), a display device (e.g., presentation device 102 or a display device associated with a server), a fixed or removable mass storage device/medium and the like.

In the case of controller 200 being used to implement a client or set top box, it will be assumed that the client or set top box comprises a device having a relatively limited amount of memory and processing power compared to a full featured desktop computer, laptop computer or server (though the client or STB may be implemented using a desktop computer, laptop computer, server or other general purpose or special purpose computer).

Within the context of an embodiment of the present invention, the controller 200 implements the invention by invoking methods associated with several resident tools; denoted herein as statdb, libdb, and arcpack tools, though only the tool function is relevant. Briefly, the Statdb and libdb tools are used to produce and maintain obfuscation libraries, which are files that are used to store and track the name mappings used in the obfuscation part of grinding. The Arcpack is the tool that does the actual grinding. These tools may be stored on a removable medium (e.g., a floppy disk, removable memory device and the like).

The invention may be implemented as a computer program product wherein computer instructions, when processed by a computer, adapt the operation of the computer such that the methods and/or techniques of the present invention are invoked or otherwise provided. Instructions for invoking the inventive methods may be stored in fixed or removable media, transmitted via a data stream in a broadcast media, and/or stored within a working memory within a computing device operating according to the instructions.

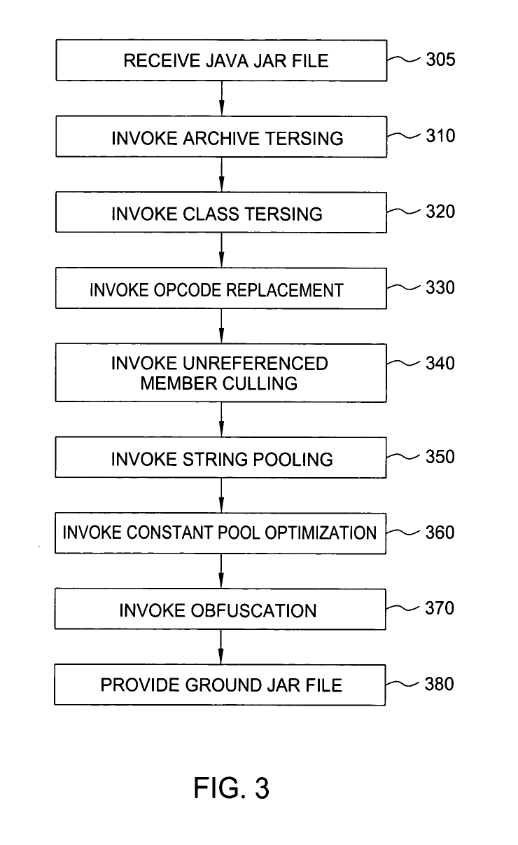

FIG. 3 depicts a flow diagram of a method according to an embodiment of the present invention. Specifically, method 300 of FIG. 3 comprises the processing of a Java jar file to provide a ground jar file. In the embodiment of FIG. 3, the steps employed are listed in a particular sequence. However, the steps of the grind process may be invoked in various other sequences and such other sequences are contemplated by the inventors.

The Grind process of the present invention may be performed by, for example, a server or other computing device implemented using the controller topology 200 discussed above with respect to FIG. 2 or other computing topology. The Grind process 300 of FIG. 3 employs the following techniques during the transformation of a Java jar to a ground jar: (step 305) receiving a Java Jar file for processing; (step 310) invoking an archive tersing method; (step 320) invoking a class tersing method; (step 330) invoking an opcode replacement method; (step 340) invoking an unreferenced member culling method; (step 350) invoking a string pooling method; (step 360) invoking a constant pool optimization method; and/or (step 370) invoking an obfuscation method and (step 380) providing a resulting ground Jar file. Each of these techniques will now be discussed in more detail.

(310) Archive Tersing Method

A Java jar file typically includes information that is not required in or critical to an embedded environment, including multiple copies of file names, file modification date and time stamps, CRC's for each file, file access permissions and the like. Archive tersing transforms the archive into a much simpler format that includes only information required for a particular application. An exemplary format of a ground archive is shown below:

```
GroundArchive
{
    U32 signature
    ArchiveEntry entry1
    .
    .
    .
    ArchiveEntry entryN
    U16 endMarker a constant value of 0
    U32 archiveCRC
}
ArchiveEntry
{
    U16 entryNameLength
    U8 name[entryNameLength]
    U32 entryDataLength
    U8 padLength
    U8 pad[padLength]
    U8 entryData[entryDataLength]
}
```

In the above example of a ground archive, for each of a plurality of archive entries only the entry name, entry data, pad and respective length information is included. Each of a plurality of archive entries is included within a ground archive along with a ground archive signature, and marker, and cyclical redundancy check (CRC) field. More or fewer archive entry fields may be employed depending upon the specific application.

In various embodiments, the information that is “required” is further restricted by considering some information as simply “non-critical,” such as error correction information that improves application processing or user experience where the absence of such information is deemed to reduce application function by an acceptable amount. This tiered form of tersing may also be applied to class tersing and other information reduction techniques discussed herein.

(step 320) Class Tersing Method

Class tersing involves transforming each class file in the Java jar into a format having a reduced size. Within the context of class tersing, one or more of the following class file structures modifications are provided: (a) removal of class attributes; (b) changes to class field attribute structure; and (c) change to method attribute structure.

Removal of class attributes comprises the deletion from the Jar file of various class attribute information, such as SourceFile and Deprecated fields.

Changes to class field attribute structure comprises modifying the class field attribute structure, such as removing all field attributes (strip ConstantValue, Synthetic, Deprecated), omitting attribute_name_index, omitting bytes_count and the like.

Changes to class method attribute structure comprises modifying the class method attribute structure, such as allowing only “Code” attributes (i.e., strip out Exceptions, Synthetic, Deprecated), omitting attribute_name_index, omitting omit bytes_count, reducing max_stack from 2 to 1 bytes, reducing max_locals from 2 to 1 bytes, reducing code_count from 4 to 2 bytes, reducing handlers_count from 2 to 1 bytes, omitting attributes_count, stripping all code attributes (e.g., LineNumberTable, LocalVariableTable) and the like.

If all of the above changes to the class file structures are implemented, there will be several new limits to the underlying Java code. Specifically, the maximum local variables per method is reduced to 255 from 65535, the maximum stack per method is reduced to 255 from 65535 and the maximum handlers per method is reduced to 255 from 65535. The maximum code size per method is unchanged.

It is noted by the inventors that the above limitation will not impact most Java code. For example, the Multimedia Home Platform (MHP) extension of the European Digital Video Broadcasting (DVB) standard utilizes Java runtime libraries consisting of approximately 2278 classes with 8096 fields and 18347 methods. Over this large body of code, the closest any limits were approached were: max local variables per method 40, max stack per method 18, max handlers 30, max code size 7552.

(step 330) Opcode Replacement Method

The Java compiler converts the Java language source code into byte codes (binary representation of the low level instruction set of the Java Virtual Machine). Opcode replacement involves replacing certain byte codes generated by the compiler with more compact versions. The Java Virtual Machine instruction set was examined by the inventors for opportunities for size reduction, and a large body of compiled Java code was analyzed for instruction usage statistics.

A set of “short” byte codes was created by the inventors to exploit the opportunities for size reduction. These byte codes use the range reserved by the Java Virtual Machine Specification for the set of “quick” byte codes. This range was selected since these byte codes are never generated by a Java compiler, they are reserved for the internal use of Java virtual machines. These short byte codes achieve size reduction by reducing constant pool indices from 16 bits to 8 bits, reducing relative branch offsets from 16 bits to 8 bits, and reducing switch offsets from 32 bits to 16 bits. Exemplary Opcode Replacements are disclosed below with respect to Table 1. It will be appreciated by those skilled in the art that various modifications to the actual replacement codes may easily be made while still practicing the invention.

TABLE 1

| Name | Byte code |
|---|---|
| invokevirtual_short | 203 |
| invokespecial_short | 204 |
| invokestatic_short | 205 |
| invokeinterface_short | 206 |
| getfield_short | 207 |
| putfield_short | 208 |
| getstatic_short | 209 |
| putstatic_short | 210 |
| checkcast_short | 211 |
| instanceof_short | 212 |
| anewarray_short | 213 |
| multianewarray_short | 214 |
| lookupswitch_short | 215 |
| tableswitch_short | 216 |
| goto_short | 217 |
| ifeq_short | 218 |
| ifne_short | 219 |
| iflt_short | 220 |
| ifle_short | 221 |
| ifnull_short | 222 |
| ifnonnull_short | 223 |
| if_icmpne_short | 224 |
| if_icmpge_short | 225 |
| if_icmplt_short | 226 |
| if_icmpeq_short | 227 |
| if_icmple_short | 228 |

(step 340) Unreferenced Member Culling Method

The grind process tracks references to methods and fields across the entire input jar and those methods and fields that are found to have zero references become candidates for removal. However, even though a field or method is not directly referenced within an archive, it might still be required. One example of this is with the Java runtime libraries built into an embedded device. A great many methods are unreferenced internally within the Java runtime, but they need to be available for applications to use. Unreferenced methods that are private may be removed from the Java runtime.

For an application, too, it is possible for a method to appear to be unreferenced, but actually still be required. Examples of this are application methods invoked by the Java runtime library such as the applet lifecycle methods. Also, methods that implement interfaces may be invoked by the Java runtime. Finally, a method that overrides a superclass method may be referenced by code that treats the object as an instance of the superclass, and hence the reference will appear to be of the superclass method implementation, not the subclass implementation.

In one embodiment, unreferenced static final field declarations are removed. Static final field declarations primarily exist for the benefit of the Java compiler. All references to static final fields of non-object type, or String object type are in-lined at compile time. The field declarations of these fields are not required at runtime.

In another embodiment, ConstantValue attributes from final fields are removed. The Java compiler will always generate code to initialize these fields by directly referencing the constant initializer in the constant pool. The ConstantValue attribute in the field declaration is not required at runtime.

The grind process determines which fields and methods may safely be removed and then removes them.

(step 350) String Pooling Method

String pooling involves creating a single table of strings for the entire jar. This eliminates the duplication of strings from class to class. String constants are illustratively stored in Java class files as Utf8 constant pool entries. The grind process determines the set of unique Utf8 strings across the jar and stores them in a single table. It then removes all Utf8 string entries from each class's constant pool, and replaces all references to the removed strings with references to the common string table. References to the strings are in the form of indexes into class constant pools, so these indexes are mapped to indexes into the common string table. Since the indices used to reference strings are 16 bits in size, this limits the maximum number of unique strings in a ground jar to 65536. As with class tersing, this limit is not often exceeded. Using MHP as an example again, the 2278 classes contain only 13649 unique strings.

The common string table is placed in the ground jar in an entry called ‘grind/Data’. This table has the following format:

$$U32 numberOfUtfStrings$$

$$U32 utfString1Offsets [ numberOfUtfStrings ]$$

$$U16 utfString1Len$$

$$U8 utfString1Data [ utfString1Len ]$$

$$⋮$$

$$U16 utfStringNLen$$

$$U8 utfStringNData [ utStringNLen ]$$

(step 360) Constant Pool Optimization Method

When constant pool optimization is used within the grind process, the constant pool of each class in the Java jar has one or more of the following operations performed on it: (a) Remove unreferenced entries; (b) Make entries a fixed size; and (c) Sort entries by type.

Examples of constant pool entries that may become unreferenced are the names of attributes that the grind tools strip from classes: all class level attributes, field and method attributes such as “Deprecated”, “Synthetic”, etc., the names of attributes that are not required when class tersing is employed: “Code”, and “ConstantValue”, and entries used by culled class members.

A problem with the Java class file format is that information is referenced from the class constant pool by index, but the constant pool entries are of variable size. This means that the Java Virtual Machine must allocate memory to create a table that maps constant pool indices to constant pool entries. The grind process converts constant pool entries to a fixed size thereby allowing the virtual machine to directly access constant pool entries by index. A fixed size of 4 bytes per entry is used. This is made possible by moving all Utf8 strings from the constant pool to a common string pool, and by removing the 8 bit type field from pool entries. Thus all pool entries fit in 4 bytes except for Long (64 bit integer) and Double (64 bit float) entries, which require 8 bytes, and are allowed to occupy two consecutive pool entries.

The constant pool is reordered by placing class, methodref, fieldref and interfacemethodref entries at the start of the pool so that they may be referenced with 8 bit indices thus maximizing the potential for the use of short opcodes. The inventors note that it is preferable not to shift a pool entry used by an ldc opcode out of the first 256 entries. If this happens, the ldc must be changed to a ldc_w opcode.

The sorted order of constant pool entries is shown below:
CONSTANT_Class,
CONSTANT_Methodref,
CONSTANT_Fieldref,
CONSTANT_InterfaceMethodref,
CONSTANT_String,
CONSTANT_Integer,
CONSTANT_Float,
CONSTANT_NameAndType,
CONSTANT_Long,
CONSTANT_Double.

Since constant pool entries no longer have a type byte, the type of an entry cannot be determined by the entry alone. To solve this, the ground class header contains the following information that allows the type of a constant pool entry to be determined.
U16 tagTypeMask
U16 tagTypes[N-1] where N is the number of bits set in tagTypeMask

A bit is set in tagTypeMask for each type of constant pool entry present in the class. The field tagTypes is an array with an entry for each type of constant pool entry present in the class. The value of the entry is the constant pool index of the first pool entry that is not of the particular pool entry type. The mask values are shown below:

| | |
|---|---|
| CONSTANT_Class | 0x8000 |
| CONSTANT_Methodref | 0x4000 |
| CONSTANT_Fieldref | 0x2000 |
| CONSTANT_InterfaceMethodref | 0x1000 |
| CONSTANT_String | 0x0800 |
| CONSTANT_Integer | 0x0400 |
| CONSTANT_Float | 0x0200 |
| CONSTANT_NameAndType | 0x0100 |
| CONSTANT_Long | 0x0080 |
| CONSTANT_Double | 0x0040 |

For example the tagTypeMask and tagTypes values shown below indicate that the constant pool contains only Class, Methodref, and NameAndType entries, and that entries 1-4 are type Class, entries 5-16 are type MethodRef, and entries 17 to the end of the table are type NameAndType.

| | |
|---|---|
| tagTypeMask: | 0xC100 |
| tagTypes: | 0x0005, 0x0011 |

(step 370) Obfuscation Method

The grind process performs two types of obfuscation, Application Obfuscation and Platform Obfuscation. Application obfuscation maps application defined class, field, and method names to shorter names. Platform or target environment obfuscation maps class, field, and method names for classes built into the target device (for example all the Java runtime library classes, and vendor specific Java libraries built into a cell phone, personal digital assistant (PDA), set top box and the like). Specifically, references in applications to class, field, method names and, more generally, symbols in the target environment get mapped to the same shorter name that was used when processing the target environment. For example, if the symbol “java.lang.Runtime” becomes “#” after grinding, then in every place where “java.lang.Runtime” is found in any application the grind process will replace the reference with “#”. This is the consistency rule that is maintained in order for ground applications to run correctly.

Since the Java libraries built into the device are known by the device vender but many applications may be built by many independent developers, a name mapping scheme that maintains a consistent mapping of platform or target environment names and independent mappings for application names is required.

That is, with respect to platform obfuscation, in addition to or in place of standard class, field and/or method names, a target device may have associated with it respective target environment defined or appropriate class, field and/or method names. In this manner, specific operational characteristics of a target environment may be exploited by applications adapted for use in the target environment by the invention. The target device operates to interpret/execute the ground Jar file to perform the various operations associated with the application provided therein.

The interpretation/execution of standard and target-specific byte code may be performed without decompressing (i.e., ungrinding) the ground Jar file, though such ungrinding may also be performed if sufficient memory exists in the target environment.

Application classes, fields, and non-interface methods use names illustratively generated from the following pool of characters: ‘a’, ‘b’, ‘c’, ‘d’, ‘e’, ‘f’, ‘g’, ‘h’, ‘i’, ‘j’, ‘k’, ‘l’, ‘m’, ‘n’, ‘o’, ‘p’, ‘q’, ‘r’, ‘s’, ‘t’, ‘u’, ‘v’, ‘w’, ‘x’, ‘y’, ‘z’, ‘A’, ‘B’, ‘C’, ‘D’, ‘E’, ‘F’, ‘G’, ‘H’, ‘I’, ‘J’, ‘K’, ‘L’, ‘M’, ‘N’, ‘O’ and ‘P.’

Application interface methods use names illustratively generated from the following pool of characters: ‘Q’, ‘R’, ‘S’, ‘T’, ‘U’, ‘V’, ‘W’, ‘X’, ‘Y’ and ‘Z.’

Platform classes, fields, and non-interface methods use names generated from the following pool of characters: ‘!’, ‘″’, ‘#’, ‘$’, ‘%’, ‘&’, ‘\’, ‘(‘,’)’, ‘*’, ‘,’, ‘-’, ‘/’, ‘0’, ‘1’, ‘2’, ‘3’, ‘4’, ‘5’, ‘6’, ‘7’, ‘8’, ‘9’, ‘:’, ‘<’, ‘=’, ‘>’, ‘?’ and ‘@.’

Platform interface methods use names generated from the following pool of characters: ‘[’, ‘\\’, ‘]’, ‘\hat{ }’, ‘_’, ‘´’, ‘{’, ‘|’, ‘}’ and ‘˜.’

Each field of each class is assigned a name mapping unique to that class by enumerating through all possible names that may be generated with the assigned character set (e.g. a, b, c, . . . aa, ab, ac, . . . ba, bb, bc, . . . ) unless the field name matches the name of a field in a superclass, in which case it is given the same name as in the superclass.

Each method of each non-interface class is assigned a name mapping unique to that class by enumerating through all possible names that may generated with the assigned character set, unless the method name matches the name of a method in a superclass, or an interface implemented by the class, or an interface implemented by a superclass, in which case it is given the same name.

Each method of each interface class is assigned a globally (among all interface methods of the appropriate type: application or platform) unique name by enumerating through all possible names that may be generated from the assigned interface name character set. Interface methods are treated specially since a class can implement multiple interfaces and hence no two interface methods can be assigned the same name mapping.

Each class is assigned a name mapping by enumerating through all possible names that may be generated with the assigned character set. Note that the name mapping replaces the fully qualified class name (e.g. ‘java/applet/Applet’ could be mapped to ‘1’).

The above rules ensure that any given name is mapped to the shortest possible obfuscated name and allows for the maximum reuse of short names. Since class names, field names, and method names are in independent name spaces, a class name could be mapped to ‘a’ and contain a method mapped to ‘a’ and a field mapped to ‘a’. Further, since name mappings are only required to be unique among all other names of the same type visible from the current point in the classed inheritance hierarchy, an application could have many methods and fields with names mapped to ‘a’.

Thus, in various embodiments of the invention, the target environment obfuscation method provides that symbols (i.e, interfaces, classes, fields, and/or methods and the like) in the target environment are replaced with shorter names. Similarly, the application obfuscation method provides that symbols (i.e, interfaces, classes, fields, and/or methods and the like) in applications are replaced with shorter names that do not overlap the names used for target environment obfuscation.

In one embodiment of the invention, an alternative mapping scheme is employed in which the above-described mapping for private symbols is used while a universal mapping for each namespace (class, field, method, interface method) for public symbols is used. For example, under a universal mapping regime, a public method named ‘myMethod’ is mapped to the same obfuscated name regardless of its position in an inheritance hierarchy in which it is defined. In other embodiment of the invention, various other combinations of private and universal mapping are employed depending on, for example, a desired level of security (e.g., reduce reverse engineering and the like), a desired level of obfuscation related compression and the like.

(step 370) Ground Class Format

In the exemplary embodiment, each ground class has the following format:

```
Grind2Class
{
    U32 signature
    U16 version
    U16 tagTypeMask
    U16 tagTypes[N−1] where N is number of bits set in
tagTypeMask
    U16 constantPoolCount
    U32 constantPool[constantPoolCount−1]
    U16 accessFlags
    U16 thisClassIndex
    U16 superClassIndex
    U16 interfaceCount
    U16 interfaces[interfaceCount]
    U16 fieldCount
    FieldInfo fields[fieldCount]
    U16 methodCount
    MethodInfo methods[methodCount]
}
FieldInfo
{
    U16 accessFlags
    U16 nameIndex
    U16 typeIndex
}
MethodInfo
{
    U16 accessFlags
    U16 nameIndex
    U16 typeIndex
    U8 maxStack
    U8 maxLocals
    U16 codeLength
    U8 code[codeLength]
    U8 handlerCount
    HandlerInfo handlers[handlerCount]
}
HandlerInfo
{
    U16 startPC
    U16 endPC
    U16 handlerPC
    U16 catchTypeIndex
}
```

Implementation Tools

The implementation of the grind process involves, illustratively, three core tools: statdb, libdb, and arcpack. Statdb and libdb are used to produce and maintain obfuscation libraries, which are files that are used to store and track the name mappings used in the obfuscation part of grinding. Arcpack is the tool that does the actual grinding.

To grind an application for a particular Java environment it is necessary to provide an obfuscation library for the target environment as well as the Java jar of the application. The invention is applicable to various bytecode interpretation environments such as the Liberate TV-Navigator middleware provided by Liberate Technologies, Inc. of San Carlos, Calif.

The obfuscation library for the target environment is created using the statdb tool. Statdb analyzes all of the Java code supplied by the target environment and sample applications that will be run on the target, and generates an optimal name mapping scheme for obfuscation. This scheme is stored in the target platform or target environment obfuscation library. For Liberate's TV Navigator, this library is called Classes.lib. Once generated, the target platform or target environment obfuscation library is incrementally updated using libdb as the target platform or target environment is modified. This allows a backwards compatible name mapping to be maintained as the target platform or target environment Java runtime evolves over time.

The statdb and libdb tools perform frequency analysis on the symbols found in applications and the target environment. The resulting statistics are used in the obfuscation phase to assign the shortest names to the most frequently referenced symbols which has the result in increasing the efficiency of the obfuscator. In this manner, the most frequently referenced symbols (interfaces, classes, methods, and fields) will be assigned the shortest obfuscated names. Statistics gathering may be performed when the initial platform grind library is created and/or during the grind process.

An additional tool denoted as trcfmt (short for “trace format”) can also be used to unobfuscate symbols. This is useful because the VM will trace or display call-stack information using the obfuscated symbols. These symbols are, by definition, useless to the programmer because they bear no resemblance to the original names used in their program. The trcfmt tool takes the call-stack or other VM output as its input along with one or more obfuscation libraries (generated during the grind process) and provides as its output the call-stack (among other items) using the original application and platform names.

The target environment or platform may comprise, for example, a resource constrained device such as a cell phone, personal digital assistant (PDA), set top box and the like. The Java libraries built into the device are known by the device vendor. A name mapping scheme maintains a consistent mapping of platform names and independent mappings for application names such that the grinding of a Jar file provides the appropriate naming of class, field, method names and the like. In this manner, efficient target device interpretation of the ground Jar application is enabled. In various embodiments of the invention, “standard” classes, fields, methods and the like are preferentially replaced by target device specific classes, fields, methods and the like such that optimizations adapted for the target environment are made during the grinding process. The target device receives a ground Jar file and iteratively resolves application defined and target environment defined class, field and method names to interpret thereby application byte codes presented within a ground Jar file. In this manner, the application is executed by the target device.

The target environment includes an interpretation engine that recognizes and interprets ground Java bytecode read from ground classes in the ground jar file. The target environment is implemented in a manner allowing it to parse the ground class file and jar formats (such as noted above with respect to step 370). The target environment is capable if interpreting the ground jar file because only the unnecessary portions were removed leaving the essential portions intact. The target environment uses the obfuscated symbols directly (rather than attempting to convert them back to their original names). This is possible because the grind process ensures that applications use the same symbol name mapping (from original name to obfuscated name) for all target environment symbols.” For example, as discussed above with respect to step ??, the symbol “java.lang.Runtime” becomes ‘v’ after grinding such that every reference to “java.lang.Runtime” in the application is replaced with a reference to “#”.

The ungrind process is the process that is used to reverse the grind process. That is, the entire grind process is reversible such that ground jar files can be reverted back into conventional Java class files with unobfuscated names. In one embodiment, the ungrind process comprises the following steps: (1) Using the obfuscation library to map from obfuscated name back to the original names (both for application and target environment symbols); (2) Padding out the truncated class file fields to their original size; (3) Inserting default values for any fields that were removed; (4) Reinserting strings from the string pool back into the appropriate class files; and (5) Restoring the class constants by reinserting their type information. The ungrinding process makes it possible for ground jars to be interpreted correctly on standard (non-grind enabled) Java VM environments.

While the foregoing is directed to certain embodiments of the present invention, these embodiments are meant to be illustrative, not limiting. Other and further embodiments of the invention may be devised without departing from the basic scope thereof, and the scope thereof is determined by the claims that follow.

1. A method for processing a Java Archive (JAR) file to provide an interpretable application file adapted for a target environment, comprising:
removing from said JAR file at least a portion of information not necessary for executing said application;
mapping at least one of application defined interface, class, field and method names to shorter names; and
mapping at least one of target environment defined interface, class, field and method names to corresponding target device names.

2. The method of claim 1, wherein said step of removing comprises:
removing unnecessary byte codes from said JAR file.

3. The method of claim 1, wherein said step of removing comprises:
removing at least one of private unreferenced methods and fields from said JAR file.

4. The method of claim 1, further comprising:
identifying within said JAR file instances of duplicate strings; and
remapping each duplicate string to a corresponding initial string.

5. The method of claim 1, further comprising:
identifying within said JAR file instances of strings;
providing a table to hold one instance of each identified string; and
remapping each identified string to a corresponding string table entry.

6. The method of claim 1, further comprising at least one of the following steps:
(a) removing unreferenced constant pool entries for at least one class;
(b) mapping constant pool entry names to fixed length names; and
(c) sorting constant pool entries by type.

7. The method of claim 1, further comprising:
preferentially remapping application references to at least one of target environment defined interface, class, field and method names.

8. The method of claim 1, wherein:
a target environment obfuscation is provided in which symbols used in the target environment are replaced with shorter names.

9. The method of claim 1, wherein:
an application obfuscation is provided in which symbols used in an application are replaced with shorter names that do not overlap the names used for target environment obfuscation.

10. The method of claim 1, further comprising:
mapping constant pool entry names to names having a fixed length.

11. The method of claim 10, further comprising:
moving strings from the constant pool to a common string pool.

12. The method of claim 1, further comprising:
assigning a global name to at least one of application and target environment methods of each interface class.

13. The method of claim 1, wherein:
said mapping steps are only used for mapping private symbols.

14. A method, comprising:
removing at least a portion of at least one of non-critical archive information, class information and unreferenced member information from a Jar file including an application;
replacing at least one of interface, class, field and method names with corresponding shorter interface, class, field and method names;
replacing at least one of target environment defined interface, class, field and method names with corresponding target device interface, class, field and method names.

15. A method, comprising:
iteratively resolving application defined and target environment defined class, field and method names to interpret application byte codes presented within a ground Jar file.

16. A signal bearing medium including a representation of software instructions which, when executed by a processor, perform a method for processing a Java Archive (JAR) file to provide an executable application file adapted for a target environment, comprising:
removing from said JAR file at least a portion of information not necessary for executing said application;
mapping at least one of application defined interface, class, field and method names to shorter names; and
mapping at least one of target environment defined interface, class, field and method names to corresponding target device names.

17. A computer program product, comprising a computer data signal embodied in a carrier wave having computer readable code embodied there in for causing a computer to process a Java Archive (JAR) file to provide an executable application file adapted for a target environment, said computer process comprising:
removing from said JAR file at least a portion of information not necessary for executing said application;
mapping at least one of application defined interface, class, field and method names to shorter names; and
mapping at least one of target environment defined interface, class, field and method names to corresponding target device names.
